(19) United States
(12) Patent Application Publication
(10) Pub. No.: US 2011/0135957 A1
(43) Pub. Date: Jun. 9, 2011

(54) PLATINUM WELD STRUCTURES AND METHODS

(76) Inventors: Martin Herbert Goller, Painted Post, NY (US); David Myron Lineman, Painted Post, NY (US)

(21) Appl. No.: 12/631,055

(22) Filed: Dec. 4, 2009

(51) Int. Cl. B32B 15/01; B23K 31/02

(52) U.S. Cl. 428/670; 228/101

(57) ABSTRACT

A platinum welded structures are provided with a first oxide dispersion strengthened platinum or platinum alloy portion and a second oxide dispersion strengthened platinum or platinum alloy portion welded to the first platinum or platinum alloy portion. The second portion is welded to the first portion with a weld joint including a platinum or platinum alloy weld bead. The weld bead further includes at least one member selected from the group consisting of Zr, ZrO₂ and rhodium at a level greater than the first and second portions. A method of making a platinum welded structure is also provided.

### TECHNICAL FIELD

The present invention relates to weld structures and methods, and more particularly to oxide dispersion strengthened precious metal weld structures and methods including oxide dispersion strengthened platinum and/or platinum alloy weld structures and methods.

### BACKGROUND

It is known to weld two pieces of oxide dispersion strengthened precious metal together. For example, alloys of the Pt—Rh group, such as Pt-10Rh, are known to be welded together to form a platinum welded structure. In the case of oxide dispersion stabilized materials, the weld joint of such a structure tends to be weaker than the base material. Such platinum welded structures are known to be used in high temperature applications. For example, such welded structures may comprise components (e.g., connecting pipes, stirring mechanisms, etc.) that interact with the glass melt in a glass melting, delivery and forming system, such as the components of a fusion draw glass making system.

### SUMMARY

The following presents a simplified summary of the disclosure in order to provide a basic understanding of some example aspects described in the detailed description.

Precious metal weld joints are strengthened by incorporating one or more additives in the welding material to alter the composition of the resulting weld joints. More particularly, weld joints containing increased levels of ZrO₂ and/or rhodium provide weld joints of increased strength including creep rupture properties. The ZrO₂ level may be increased by initially increasing the Zr level in the weld joint and treating the weld joint to convert the Zr to ZrO₂ as by oxidation annealing.

In one example, a platinum welded structure is provided with a first oxide dispersion strengthened platinum or platinum alloy portion and a second oxide dispersion strengthened platinum or platinum alloy portion welded to the first platinum or platinum alloy portion. The platinum alloys of the first and second portions may be of the same composition or different compositions. The second portion is welded to the first portion with a weld joint including a platinum or platinum alloy weld bead. The weld bead further includes at least one member selected from the group consisting of Zr, ZrO₂ and rhodium at a level greater than that in the first and second portions.

A method of making a platinum welded structure is also provided. As noted above, a weldment may be provided of oxide dispersion strengthened platinum or platinum alloy portions joined by a weld joint or weld bead containing increased levels of at least one of ZrO₂ and/or rhodium as compared with the levels or amounts of such constituents in the portions to be joined. The ZrO₂ level may be increased during the welding process per se by converting Zr contained in the weld material to ZrO₂ or by initially increasing the Zr level in the weld joint and treating the weld joint to convert the Zr to ZrO₂ as by oxidation annealing. In the foregoing methods, the strength of the weld including the creep rupture strength are increased by the greater levels of ZrO₂ and/or rhodium as compared with the levels or amounts of such constituents in the portions to be joined and weld joints formed of weld fillers of the materials of such portions.

Several aspects of the present invention are disclosed herein. It is to be understood that these aspects may or may not overlap with one another. Thus, part of one aspect may fall within the scope of another aspect, and vice versa. Unless indicated to the contrary in the context, the differing aspects shall be considered as overlapping with each other in scope.

Each aspect is illustrated by a number of embodiments, which, in turn, can include one or more specific embodiments. It is to be understood that the embodiments may or may not overlap with each other. Thus, part of one embodiment, or specific embodiments thereof, may or may not fall within the ambit of another embodiment, or specific embodiments thereof, and vice versa. Unless indicated to the contrary in the context, the differing embodiments shall be considered as overlapping with each other in scope.

Thus, according to a first aspect, a platinum welded structure comprises: (i) a first oxide dispersion strengthened platinum or platinum alloy portion; and (ii) a second oxide dispersion strengthened platinum or platinum alloy portion welded to the first platinum or platinum alloy portion with a weld joint including a platinum or platinum alloy weld bead, wherein the weld bead further includes at least one member selected from the group consisting of Zr, ZrO₂ and rhodium at a level greater than the first and second portions.

In certain embodiments of the first aspect, the weld bead includes ZrO₂ at a level greater than the first and second portions.

In certain embodiments of the first aspect, the weld bead includes from about 0.1 wt % to about 1 wt % ZrO₂.

In certain embodiments of the first aspect, the weld bead includes from about 0.2 wt % to about 1 wt % ZrO₂.

In certain embodiments of the first aspect, the weld bead comprises an oxide dispersion-stabilized platinum alloy.

In certain embodiments of the first aspect, the platinum alloy of the weld bead comprises at least one member selected from the group consisting of ruthenium, rhodium, palladium, osmium, iridium, and gold.

In certain embodiments of the first aspect, the platinum alloy of the weld bead comprises a third platinum-rhodium alloy.

In certain embodiments of the first aspect, the third platinum-rhodium alloy has a weight ratio of platinum to rhodium that is at least about 1:1.

In certain embodiments of the first aspect, the third platinum-rhodium alloy has a weight ratio of platinum to rhodium that is at least about 4:1.

In certain embodiments of the first aspect, the third platinum-rhodium alloy has a weight ratio of platinum to rhodium that is at least about 9:1.

In certain embodiments of the first aspect, the third platinum-rhodium alloy comprise a higher percentage of rhodium than the first oxide dispersion strengthened platinum or platinum alloy portion and the second oxide dispersion strengthened platinum or platinum alloy portion.

In certain embodiments of the first aspect, at least one of the first platinum or platinum alloy portion and the second platinum or platinum alloy portion comprises a platinum-rhodium alloy.

A second aspect of the present invention is directed to a method of making a platinum welded structure comprising the steps of: (A) providing a first oxide dispersion strengthened platinum or platinum alloy portion and a second oxide dispersion strengthened platinum or platinum alloy portion; (B) providing a platinum-containing welding material; and (C) welding the first platinum or platinum alloy portion to the second platinum or platinum alloy portion with the platinum-containing welding material, wherein the step of welding includes forming a platinum or platinum alloy weld bead including at least one member selected from the group consisting of Zr, ZrO₂ and rhodium at a level greater than the first and second portions.

In certain embodiments of the second aspect, the weld bead includes ZrO₂ at a level greater than the first and second portions.

In certain embodiments of the second aspect the weld bead includes from about 0.1 wt % to about 1 wt % ZrO₂.

In certain embodiments of the second aspect, the weld bead includes from about 0.2 wt % to about 1 wt % ZrO₂.

In certain embodiments of the second aspect, the weld bead comprises a third oxide dispersion-stabilized platinum alloy.

In certain embodiments of the second aspect, the third platinum alloy of the weld bead comprises at least one selected from the group consisting of ruthenium, rhodium, palladium, osmium, iridium, and gold.

In certain embodiments of the second aspect, the third platinum-rhodium alloy has a weight ratio of platinum to rhodium that is at least about 1:1.

In certain embodiments of the second aspect, said at least one member is Zr and further including the step of converting at least a portion of said Zr to ZrO₂ whereby the ZrO₂ level in said weld bead is greater then in said first and second portions.

In certain embodiments of the second aspect, the third platinum-rhodium alloy comprise a higher percentage of rhodium than the first oxide dispersion strengthened platinum or platinum alloy portion and the second oxide dispersion strengthened platinum or platinum alloy portion.

In certain embodiments of the second aspect, in the welding step, the welding material is maintained in an oxidizing atmosphere to prevent reducing of ZrO₂ to Zr.

### BRIEF DESCRIPTION OF THE DRAWINGS

These and other aspects are better understood when the following detailed description is read with reference to the accompanying drawings, in which:

FIG. 1 is a diagrammatic top view of an example of first and second oxide dispersion strengthened platinum or platinum alloy portions to be welded together in accordance with the present invention;

FIG. 2 is a top view similar to FIG. 1 showing the portions being partially welded with a welding rod and a welding torch;

FIG. 3 is a cross sectional view along line 3-3 of FIG. 2, showing the portions being positioned in contact with each other before welding;

FIG. 4 is a cross sectional view along line 4-4 of FIG. 2, showing the weld joint as formed by the welding rod and welding torch to join the portions;

FIG. 5 is a diagrammatic top view showing the portions completely welded together with a weld joint in accordance with certain embodiments of the invention including a platinum or platinum alloy weld bead;

FIG. 6 is a graph showing the creep rupture data of unwelded sheet stock and sheet stocks welded with different weld fillers; and

FIG. 7 is a graph showing the lifetime prediction of the sheet stocks welded with different weld fillers.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

Platinum welded structures or weldments may be formed with various oxide dispersion strengthened platinum or platinum alloy portions. Such platinum welded structures may be used in various high temperature applications such as the components of a glass melting, delivery, handling, conditioning and forming system. In such an application, platinum welded structures can comprise stirring mechanisms, connecting pipes, fittings or other components of a glass melting, delivery, conditioning, handling and forming system, such as those used in and for a fusion draw glass forming process.

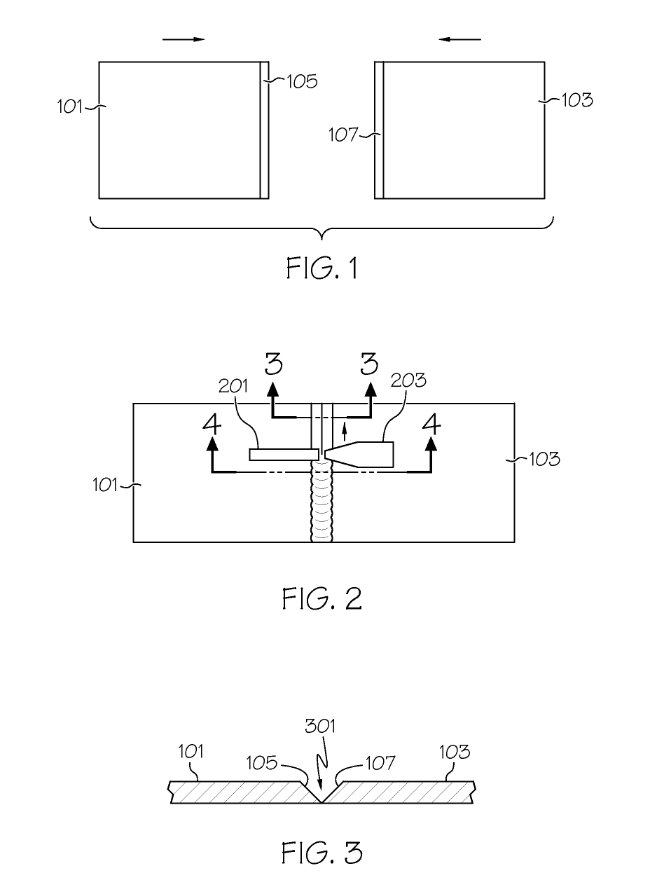

An example of such a structure comprising first and second oxide dispersion strengthened platinum or platinum alloy portions 101, 103 is shown in FIG. 1. As shown, the first portion 101 may include a first welding edge 105 and the second portion 103 may include a second welding edge 107. The first and second portions 101, 103 may have the same or different compositions. For example, the oxide dispersion strengthened portions 101, 103 may each be formed of platinum, the same or different platinum alloys or combinations thereof. At least one of the first and second portions 101, 103 may comprise an oxide dispersion strengthened platinum-rhodium alloy. Illustrative oxide dispersion strengthened platinum-rhodium alloys include Pt-10Rh and Pt-20Rh.

As shown in FIG. 1, the first and second portions 101, 103 are moved toward each other in the arrowed direction. Then, as shown in FIG. 3, the first welding edge 105 of the first portion 101 may be brought into contact with the second welding edge 107 of the second portion 103. In order to effectively weld the first portion 101 to the second portion 103, the first and second welding edges 105, 107 may be closely positioned with respect to one another, e.g., contacted with one another, to provide an area for forming a weld joint therebetween. As shown, the first welding edge 105 and the second welding edge 107 can be tapered to form a space 301 in which the weld joint may be formed.

In accordance with certain embodiments of the invention, a welding rod 201 is formed of a platinum-containing welding material including an additive material comprising at least one member selected from the group consisting of Zr, ZrO₂ and/or Rh at a level greater than the first and second portions. During welding, the Zr in the welding material will form ZrO₂ with available oxygen. The resulting weld bead or joint contains ZrO₂ and/or Rh at a level greater than the first and second portions. Also, as noted above, the weld bead may contain a high level of Zr that is converted at least in-part to ZrO₂ by subsequent processing such as oxidation annealing. Accordingly, the welding rod or filler material includes Zr, ZrO₂ and/or Rh in an amount sufficient to form a weld joint having increased strength including an increased resistance to creep rupture.

Examples of the platinum-containing welding material include oxide dispersion stabilized platinum alloys. The oxide dispersion stabilized platinum alloy may contain about 0.2 wt % to about 2 wt % ZrO₂, or about 0.4 wt % to about 2 wt % ZrO₂. The upper limit of ZrO₂ is determined by the manufacturability of the welding material and the shape requirements of the welded structure. The platinum-containing welding material may be a platinum alloy welding material. The platinum alloy welding material may include other metals such as ruthenium, rhodium, palladium, osmium, iridium, gold, and the like. In one example, the platinum alloy welding material is a platinum-rhodium alloy. The percentage of rhodium in the platinum-rhodium alloy welding material may be higher than 40 wt %, but may be within the range from about 10 wt % to about 40 wt %.

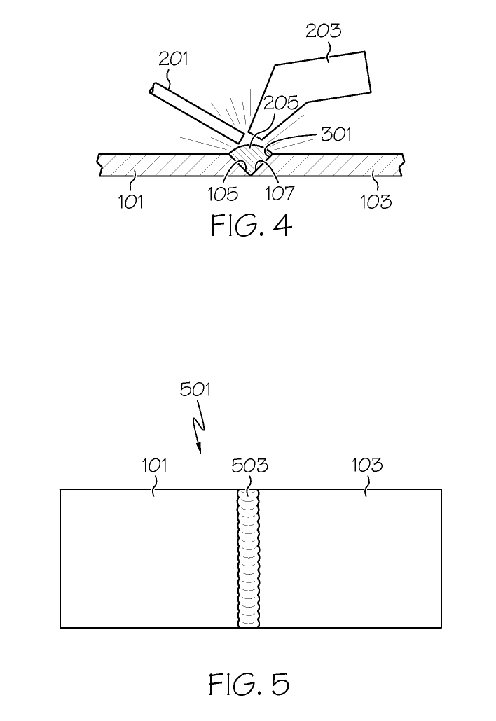

As shown in FIG. 4, the welding rod 201 is placed adjacent the space 301 formed by disposing the first and second welding edges 105, 107 together. Using a torch 203 and the welding rod 201, the portions 101, 103 are torch welded together with the formation of a weld bead 205. The welding methods include any standard welding methods such as TIG welding, etc., and do not require special welding methods such as hammer welding, etc.

By using the above welding method, a platinum welded structure 501 is formed, as shown in FIG. 5. The platinum welded structure 501 comprises the first oxide dispersion strengthened platinum or platinum alloy portion 101, the second oxide dispersion strengthened platinum or platinum alloy portion 103, and a weld joint 503. The weld joint 503 includes the weld bead 205.

In accordance with the composition of the welding rod 201 and the particular additive material or materials therein, the weld bead 205 includes ZrO₂ and/or Rh at a level greater than the first and second portions 101, 103 and up to about 0.4 wt % and 50 wt % for Rh. In one example, the weld bead 205 includes ZrO₂ at a level greater than the first and second portions 101, 103. In another example, the weld bead 205 includes from about 0.1 wt % to about 1 wt % ZrO₂, or about 0.2 wt % to about 1 wt % ZrO₂. The increased level of ZrO₂ in the weld bead improves the mechanical performance of the welded joint. A welding material having a higher level of Zr and/or ZrO₂ will provide a higher residual level of ZrO₂ in the weld bead 205, which contributes to the improved creep behavior of the weld bead 205. Alternatively, the weld bead 205 may include rhodium at a level greater than the first and second portions, and up to about 50 wt %. In one example, the weld bead may contain Rh at a level of from about 10 wt % to about 50 wt % and, more preferably, from about 30 wt % to about 50 wt %. A higher rhodium level in the weld bead 205 will also provide the improved mechanical strength of the weld bead 205. In one example, the welding material includes Pt-50Rh.

The weld bead 205 may include an oxide dispersion-stabilized platinum alloy. The platinum alloy of the weld bead 205 may include other metals such as ruthenium, rhodium, palladium, osmium, iridium, gold, and the like. In one example, the platinum alloy of the weld bead 205 is a platinum-rhodium alloy. The ratio of platinum to rhodium in the platinum-rhodium alloy of the weld bead 205 may be at least about 1:1, or at least about 4:1, or at least about 9:1.

The platinum welded structure 501 shown in FIG. 5 is tested for its mechanical strength by using an ASTM E 139 style creep rupture test at 1700° C. The creep rupture test is performed by imposing a constant degree of stress on the platinum welded structure 501, and measuring the time in hours which is required for the rupture of the platinum welded structure 501.

For testing purposes, the first and second portions 101, 103 were formed of commercially available sheet stock material having a thickness of 0.030″ and a composition containing 90 wt % platinum, 10 wt % rhodium and 0.16-0.2 wt % ZrO₂. These portions were welded as described above using welding rods 201 of the following compositions reported in Table 1.

TABLE 1
Filler Materials/Welding Rods

| Component | Material 1 (wt %) | Material 2 (wt %) | Material 3 (wt %) |
|---|---|---|---|
| Platinum | 90 | 90 | 90 |
| Rhodium | 10 | 10 | 10 |
| ZrO₂ before | 0.16-0.2 | 0.4 | 0.16-0.2 |
| welding | | | |

Material 1 illustrates the practice of using welding rod or filler material formed as a strip of the material being fabricated and therefore having the same composition. Material 2 is in accordance with certain embodiments of the invention and imparts to the weld bead 205 a ZrO₂ content greater than that contained in the first and second portions. Material 3 is made of a different process from Material 1. It is believed that the Material 3 resulted in a higher level of ZrO₂ after welding than Material 1. Material 3 further comprises rare earth at a minor amount.

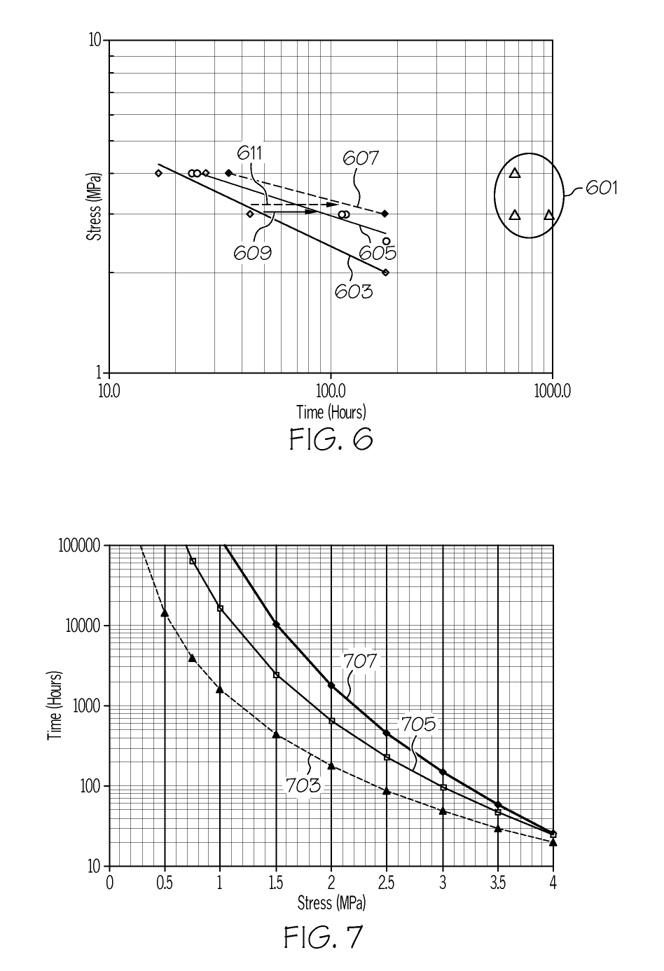

The welded structures resulting from the use of Materials 1-3 are subjected to the creep rupture test. FIG. 6 shows the results of the creep rupture test wherein the x-axis represents time in hours and the y-axis represents stress in MPa. As represented by the triangular data points 601 shown in FIG. 6, the unwelded sheet stock did not break and the tests were aborted. On the other hand, according to FIG. 6, the sheet stock welded with Material 3 is represented by the line 607 that shows the best results, followed by Material 2 represented by line 605, and then Material 1 represented by line 603. Indeed, increased creep rupture characteristics of Material 2 compared to Material 1 is represented by the shift of the line 605 relative to line 603 along direction 609. Likewise, increased creep rupture characteristics of Material 3 compared to Material 1 is represented by the shift of the line 607 relative to the line 603 along direction 611. It is clear from FIG. 6 that when the amount of ZrO₂ in the welding material is increased from 0.16-0.2 wt % to 0.4 wt %, the creep rupture performance is dramatically improved under the same stress in MPa.

FIG. 7 shows the lifetime prediction of the creep rupture weldments prepared using each of Materials 1, 2 and 3 as described above. The x-axis represents the stress in MPa and the y-axis represents the time in hours. Material 1 is represented by the function 703, Material 2 is represented by function 705 and Material 3 is represented by function 707. As shown in FIG. 7, the lifetime creep rupture performance is also dramatically improved from Material 1 to Material 2, as the level of ZrO₂ in the welding material is increased from 0.16-0.2 wt % to 0.4 wt %.

According to the present invention, a welded structure with the improved mechanical strength is provided. The improved mechanical strength will contribute to the cost reduction efforts by allowing the welded structure to be thinner. For example, it is possible to reduce the thickness of the welded structure from 0.040″ to 0.030″.

It will be apparent to those skilled in the art that various modifications and variations can be made without departing from the spirit and scope of the claimed invention.

What is claimed is:

1. A platinum welded structure comprising:
a first oxide dispersion strengthened platinum or platinum alloy portion;
a second oxide dispersion strengthened platinum or platinum alloy portion welded to the first platinum or platinum alloy portion with a weld joint including a platinum or platinum alloy weld bead, wherein the weld bead further includes at least one member selected from the group consisting of Zr, ZrO₂ and rhodium at a level greater than the first and second portions.

2. The platinum welded structure of claim 1, wherein the weld bead includes ZrO₂ at a level greater than the first and second portions.

3. The platinum welded structure of claim 2, wherein the weld bead includes from about 0.1 wt % to about 1 wt % ZrO₂.

4. The platinum welded structure of claim 3, wherein the weld bead includes from about 0.2 wt % to about 1 wt % ZrO₂.

5. The platinum welded structure of claim 1, wherein the weld bead comprises a third oxide dispersion-stabilized platinum alloy.

6. The platinum welded structure of claim 5, wherein the third platinum alloy of the weld bead comprises at least one member selected from the group consisting of ruthenium, rhodium, palladium, osmium, iridium, and gold.

7. The platinum welded structure of claim 6, wherein the third platinum alloy has a weight ratio of platinum to rhodium that is at least about 1:1.

8. The platinum welded structure of claim 7, wherein the third platinum alloy has a weight ratio of platinum to rhodium that is at least about 4:1.

9. The platinum welded structure of claim 8, wherein the third platinum alloy has a weight ratio of platinum to rhodium that is at least about 9:1.

10. The platinum weld structure of claim 6, wherein the third platinum alloy comprise a higher percentage of rhodium than the first oxide dispersion strengthened platinum or platinum alloy portion and the second oxide dispersion strengthened platinum or platinum alloy portion.

11. The platinum welded structure of claim 1, wherein at least one of the first platinum or platinum alloy portion and the second platinum or platinum alloy portion comprises a platinum-rhodium alloy.

12. A method of making a platinum welded structure comprising the steps of providing a first oxide dispersion strengthened platinum or platinum alloy portion and a second oxide dispersion strengthened platinum or platinum alloy portion;
providing a platinum-containing welding material; and
welding the first platinum or platinum alloy portion to the second platinum or platinum alloy portion with the platinum-containing welding material, wherein the step of welding includes forming a platinum or platinum alloy weld bead including at least one member selected from the group consisting of Zr, ZrO₂ and rhodium at a level greater than the first and second portions.

13. The method of claim 12, wherein the weld bead includes ZrO₂ at a level greater than the first and second portions.

14. The method of claim 13, wherein a weight of the weld bead includes from about 0.1 wt % to about 1 wt % ZrO₂.

15. The method of claim 14, wherein the weight of the weld bead includes from about 0.2 wt % to about 1 wt % ZrO₂.

16. The method of claim 12, wherein the weld bead comprises an oxide dispersion-stabilized platinum alloy.

17. The method of claim 16, wherein the platinum alloy of the weld bead comprises at least one selected from the group consisting of ruthenium, rhodium, palladium, osmium, iridium, and gold.

18. The method of claim 17, wherein the platinum alloy of the weld bead comprises a third platinum-rhodium alloy.

19. The method of claim 18, wherein the third platinum-rhodium alloy has a weight ratio of platinum to rhodium that is at least about 1:1.

20. The method of claim 12, wherein said at least one member is Zr and further including the step of converting at least a portion of said Zr to ZrO₂ whereby the ZrO₂ level in said weld bead is greater then in said first and second portions.

21. The method of claim 18, wherein the third platinum-rhodium alloy comprise a higher percentage of rhodium than the first oxide dispersion strengthened platinum or platinum alloy portion and the second oxide dispersion strengthened platinum or platinum alloy portion.

22. The method of claim 12, wherein in the welding step, the welding material is maintained in an oxidizing atmosphere to prevent reducing of ZrO₂ to Zr.
